(19) United States
(12) Patent Application Publication
(10) Pub. No.: US 2015/0082632 A1
(43) Pub. Date: Mar. 26, 2015

(54) METHOD FOR PRODUCING AN ALUMINUM PISTON

(71) Applicant: Mahle International GmbH, Stuttgart (DE)

(72) Inventors: Karlheinz Bing, Remseck (DE); Thomas Hackh, Stuttgart (DE); Frank Schnaiter, Ditzingen (DE)

(21) Appl. No.: 14/388,682

(22) PCT Filed: Mar. 25, 2013
(86) PCT No.: PCT/EP2013/056234

§ 371 Date: Sep. 26, 2014

(30) Foreign Application Priority Data
Mar. 28, 2012 (DE) 102012204947.9

(51) Int. Cl. B23P 15/10

(52) U.S. Cl. CPC B23P 15/10
USPC 29/888.04

(57) ABSTRACT

A method for producing an aluminum piston for an internal combustion engine may including providing a piston bowl having a bowl edge and a bowl base; subjecting an area of at least one of the bowl edge and the bowl base to a welding treatment to introduce at least one additional element into a base material of the piston bowl and to produce intermetallic phases in the base material; the welding treatment may introduce at least one of the following additional elements at the specified concentrations, 1-7 wt. percentage of Ni, 1-15 wt. percentage of Cu and 1-5 wt. percentage of Fe.

### CROSS-REFERENCE TO RELATED APPLICATIONS

This application claims priority to German Patent Application No. 10 2012 204 947.9, filed Mar. 28, 2012, and International Patent Application No. PCT/EP2013/056234, filed Mar. 25, 2013, both of which are hereby incorporated by reference in their entireties.

### TECHNICAL FIELD

The present invention relates to a method for producing an aluminium piston for an internal combustion engine, said aluminium piston being subjected to a welding treatment at least in the area of a bowl edge and/or a bowl base in accordance with the preamble of claim 1. The invention also relates to an aluminium piston produced using such a method.

### BACKGROUND

The remelting of aluminium pistons in the bowl region is one possible means of significantly increasing the strength, and therefore also the service lifetime, of the aluminium piston. Such remelting process are limited, however, because in particular in the case of pistons subject to high thermal stress it has been shown that a macroscopically visible degree of surface damage can be produced in the region of the focussed beam. Microscopic examination reveals that the damage is due to thermo-mechanical fatigue, the cracking primarily occurring at the phase boundary between the primary silicon and the aluminium matrix. The damage is attributed to two causes. The first is that the primary silicon/aluminium matrix phase boundary represents a weak point in terms of the strength of the material, which is exacerbated by the different thermal expansion coefficients of the two phases. Secondly the high temperatures lead to a deformation and degradation of the silicon skeleton, resulting in a local reduction of the strength of the alloy and ultimately making cracking due to temperature change more likely. In order to obtain as high a resistance as possible to thermo-mechanical cracking, it is therefore desirable to prevent this effect, or at least to mitigate it.

EP 1 386 687 B1 discloses a method of generic kind for producing an aluminium piston, in which the welding treatment is carried out using an arc welding method and after the welding treatment the piston is cooled down at a rate of 100-1000 K/s. It was found that increasing the cooling rate results in an increasing fineness of the crystallizing particles in the melt. Overall, with the known method an improved resistance to thermal fatigue is achieved.

DE 10 2005 034 905 A1 discloses an additional method for producing a piston for an internal combustion engine, in which at least one area of the combustion chamber bowl comprising at least one bowl base is welding treated, in order to remelt a material in the welding treatment area, which means that a build-up of the material in the welding treatment area can be controlled in a layer with a specifiable depth.

Further methods for producing a piston are known from both DE 199 02 864 A1 and DE 691 02 313 T2.

DE 600 22 845 T2 also discloses a method for strengthening an aluminium piston of an internal combustion engine, the method comprising a step of applying an alloy containing copper and nickel by melting on at least one section of the edge or the perimeter of the combustion chamber bowl.

It is well known that the strength of AlSi piston alloys is increased by the addition of copper, nickel, iron, magnesium and other elements and the resultant formation of intermetallic phases. Higher proportions of these alloying elements also lead to higher strengths. Under thermo-mechanical stress an increase in the strength represents a minimization of the cyclical-plastic strain, which means that under thermo-mechanical stress such a material deforms in a more highly elastic and less plastic manner, which is beneficial for the service life. The increase in the alloying elements is subject to limits, however, because in particular with increasing amounts of the alloying elements Ni, Cu and Fe, intermetallic phases are formed that tend to be large or have the form of coarse needles or splinters. These have a detrimental effect, because a brittle material behaviour is obtained and the durability is thus greatly reduced. This negates the above-mentioned advantage, or depending on the alloy composition, can even make the situation worse. For an adequate durability of the alloy however, it is absolutely necessary to generate the intermetallic phases in the structure in as finely dispersed a manner as possible. A known solution to this problem is to increase the solidification rate, since at a higher solidification rate the intermetallic phases have less time to grow and thereby develop a finer structure. In the gravity die-casting processes used for piston production however, solidification rates can only be increased within limits that are usually set so low that the technically feasible solidification rates are not adequate to produce a sufficiently fine structure with higher proportions of copper, nickel or iron without allowing coarse intermetallic phases to develop. To avoid this problem, therefore, in particular in the case of aluminium pistons the desired alloys are produced by local welding methods. Of great advantage here is that, due to the aluminium piston, which acts as a heat sink, the heat of the relatively small melt bath can be dissipated extremely quickly, which results in the formation of markedly finer intermetallic phases. However, in practice it has been shown that, although overall an increased fineness of the intermetallic phases is obtained, this is combined with two adverse effects. Firstly, isolated occurrences of large-scale, hard intermetallic phases are generated, which by virtue of their size must be regarded as very disadvantageous. Secondly, very large splinter-like intermetallic phases form in increasing numbers, and these are therefore highly undesirable. The factors that lead to the formation of the microstructures of the material depend, among other things, on the additive, its concentration and distribution in the melt bath, the base material, the level of energy input, the welding method used, etc.

### SUMMARY

The present invention is thus concerned with the problem of overcoming the known disadvantages of the prior art and, in particular, to greatly reduce or completely eliminate large-scale, coarse needle-like or splinter-like intermetallic phases, and thus to obtain a higher resistance to thermal fatigue in the treated areas.

This problem is solved according to the invention by the subject matter of the independent claims. Advantageous embodiments are the subject matter of the dependent claims.

The present invention is based on the general idea that to produce a known aluminium piston for an internal combustion engine, said piston being subjected to a welding treatment at least in the area of a bowl edge and/or a bowl base in order to introduce at least one additional element in a base material of the aluminium piston and to generate intermetallic phases, a particular selection of the additional element or additive materials is to be made and preferably, in order to introduce said additional element, a welding process with a predefined ratio of arc energy per unit length to weld penetration area E/A is to be used. According to the invention, using the welding process at least one of the following additional elements is introduced in the specified concentration, namely 1-7 wt. % Ni, 1-15 wt. % Cu and/or 1-5 wt. % Fe. In addition, in the method according to the invention one of the following welding processes can be used, arc welding such as tungsten inert-gas welding (TIG) with E/A=7-17 J/mm³ or plasma welding (WP) with E/A=6-16 J/mm³, laser beam welding with E/A=80-90 J/mm³ or electron beam welding with E/A=5-15 J/mm³. Efficiency losses of the welding methods mentioned, for example due to heat radiation, reflection, etc., are not taken into account. In particular, due to the combination of the above-mentioned welding methods with the corresponding arc energy/weld penetration area ratio E/A and the above-mentioned additional elements and the corresponding concentration, a microstructure can be fashioned in which the respective intermetallic phases ideally have a maximum longitudinal extension of L<50 microns, and are therefore very finely structured.

Alternatively, to introduce the additional elements or additive materials a welding method with a defined arc energy E (J/mm) per unit length can be used, in which case the element should preferably be preheated. According to the invention using the welding process at least one of the following additional elements is introduced in the specified concentration, namely 1-7 wt. % Ni, 1-15 wt. % Cu and/or 0.5-5 wt % Fe. In a further preferred embodiment the additive metal can contain 0.5-1 wt. % Fe.

In addition, in the method according to the invention one of the following welding processes can be used, an arc welding method such as tungsten inert-gas welding (TIG) with E=150-450 J/mm, or plasma welding (WP) with E=250-700 J/mm, laser beam welding with E=100-400 J/mm or electron-beam welding with E=500-900 J/mm, where the element is to be preferably pre-heated to a temperature between 100-300° C. In particular, by the combination of the above-mentioned welding methods with the given arc energy per unit length, the pre-heating and the given additional elements and the associated concentration a microstructure can be set up in which the respective intermetallic phases ideally have a maximum longitudinal extension of L<50 microns and are therefore very finely structured.

In general, the prevention of the known negative effects of the prior art was linked to numerous process parameters which interact with each other to different degrees. It was all the more surprising that in spite of the above complex relationships a processing window could be determined which allows a structure with finely distributed intermetallic phases to be generated and which also does not contain the coarse needle-like, splinter-like or large-area intermetallic phases. Due to the absence of such coarse intermetallic phases, when the inherent strength is raised the durability is not especially adversely affected either. Under high-temperature loading the finely distributed inner-metallic phases help to support the primary silicon particles developing in the mould and therefore stabilise the silicon skeleton.

In an advantageous extension the concentrations of the additional elements added using the welding process according to the invention are 2-7 wt. % for Ni, 3-15 wt. % for Cu and 1-5 wt. % or 0.5-5 wt % for Fe. This is a further restriction of the concentrations of the individual additional elements described in the previous paragraph, which means a further increase in the strength can be achieved. It is of course completely obvious that the above-mentioned elements nickel, copper and iron may be added not only in combination, but also individually at the respective concentration.

In an advantageous extension of the method according to the invention, a base material is used for the aluminium piston with the following composition: Al 60-90 wt. %, Si 8-20 wt. %, Cu 2-6 wt. %, Ni 1-4 wt. % and Mg 0.2-2 wt. %. Particularly preferably, the elements are limited as follows: Al 75-85 wt. %, Si 10-13 wt. %, Cu 3.5-5 wt. %, Ni 1.5-2.5 wt. % and Mg 0.5-1.5 wt. %. In addition, the base material can of course contain other small proportions of iron, manganese, titanium, zirconium, calcium, strontium, sodium, phosphorus or vanadium, in particular in the form of trace elements, but also added in a selective manner. In particular, such an aluminium alloy is particularly resistant to the high thermal and mechanical forces that occur in the operation of internal combustion engines, in particular in diesel engines.

Other key features and advantages of the invention follow from the dependent claims, from the drawing and from the associated description of the figures based on the drawing.

It goes without saying that the above-mentioned features and those yet to be explained hereafter can be applied not only in the corresponding specified combination, but also in other combinations, or in isolation without departing from the scope of the present invention.

A preferred exemplary embodiment of the invention is shown in the drawing and is explained in more detail in the following description.

### BRIEF DESCRIPTION OF THE DRAWINGS

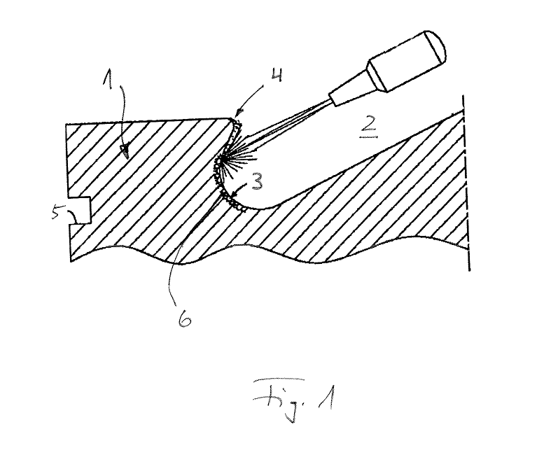

The single FIG. 1 shows an introduction of additional elements into a bowl edge of a piston using the method according to the invention.

### DETAILED DESCRIPTION

According to FIG. 1, an aluminium piston 1 produced by means of a method according to the invention has a bowl 2, facing a combustion chamber not shown in detail, with a bowl base 3 and a bowl edge 4. Around the circumference, annular grooves 5 are provided in a known manner for receiving piston rings, not shown.

In order to now make the aluminium piston 1 more resistant, in particular in areas under high thermal and mechanical stress, namely in the region of the bowl base 3 and/or of the bowl edge 4, at least one additional element is introduced into a base material of the aluminium piston 1 by means of a method according to the invention, in order to produce intermetallic phases 6. With the welding method according to the invention at least one of the following additional elements is introduced into the bowl edge 4 and/or the bowl base 3 in the specified concentration, namely 1-7 wt. % Ni, 1-15 wt. % Cu and 1-5 wt. % Fe. The concentration of Ni is preferably limited to 2-7 wt. % and the concentration of Cu to 3-15 wt. %. Also, as the welding method one of the following welding methods with the specified arc energy/weld penetration area ratio E/A (J/mm³) is used: arc welding, such as tungsten inert gas welding (TIG) with E/A=7-17 J/mm³, or plasma welding (WP) with E/A=6-16 J/mm³, laser beam welding with E/A=80-90 J/mm³ or electron beam welding with E/A=5-15 J/mm³.

In another embodiment, at least one of the following additional elements is introduced into the bowl edge 4 and/or the bowl base 3 in the specified concentration using the welding method according to the invention, namely 1-7 wt. % Ni, 1-15 wt. % Cu and 0.5-5 wt. % Fe. The concentration of Ni is preferably limited to 2-7 wt. % and the concentration of Cu to 3-15 wt. %. Also, as the welding method one of the following welding methods with the specified arc energy/weld penetration area ratio E/A (J/mm³) is used: arc welding, such as tungsten inert gas welding (TIG) with E/A=150-450 J/mm³, or plasma welding (WP) with E/A=250-700 J/mm³, laser beam welding with E/A=100-400 J/mm³ or electron beam welding with E/A=500-900 J/mm³.

It should be added here that the additional elements can be introduced into the bowl base 3 or the bowl edge 4 not only in the specified combination, but also in isolation in the respective concentration indicated.

By means of the welding method according to the invention, taking into account the concentrations of the additional elements indicated and taking into account the types of welding methods, intermetallic phases 6 can be produced with ideally a maximum longitudinal extension of L<50 microns, which means that the intermetallic phases are overall very finely structured, and in particular coarse needle-like or splintered phases can thereby be prevented. Due to the absence of the coarse structural characteristics, such as coarse needle-like phases, with increased inherent strength the durability is not adversely affected, and so at high temperatures the finely distributed intermetallic phases 6 help to support the primary silicon particles developing in the mould and therefore also to stabilise the silicon skeleton.

The base material used for the aluminium piston 1 can have a composition with 60-90 wt. % Al, 8-20 wt. % Si, 2-6 wt. % Cu, 1-4 wt. % Ni and 0.2-2 wt. % Mg. It is preferable if the components of Al are limited to 75-85 wt. %, the Si components to 10-13 wt. %, the components of Cu to 3.5-5 wt. %, the components of Ni to 1.5-2.5 wt. % and the components of Mg to 0.5-1.5 wt. %. The base material of the aluminium piston 1 can, of course, be supplemented by other elements either in the form of trace elements, or also added in a targeted manner, such as Fe, Mn, Ti, Zr, Ca, Sr, Na, P, and/or V, each at a concentration of <1 wt %. The additional elements Ni, Cu and/or Fe can be added directly to the molten pool, for example, in the form of a powder or a wire, during the welding process, wherein the additional elements can of course be applied to the base material of the aluminium piston 1 before the welding process itself using thermal spraying, cold gas spraying, foil, paste, galvanic or chemical deposition.

With the welding method according to the invention and the welding parameters or additional elements used in this method, particularly fine intermetallic phases 6 can be generated, while in particular coarse needle-like or splinter-like phases can be prevented, allowing the durability of an aluminium piston 1 produced in such a manner to be increased significantly.

1. A method for producing an aluminium piston for an internal combustion engine, comprising: providing a piston bowl having a bowl edge and a bowl base, subjecting an area of at least one of the bowl edge and the bowl base to a welding treatment to introduce at least one additional element into a base material of the piston bowl and to produce intermetallic phases in the base material, wherein the welding treatment introduces at least one of the following additional elements at the specified concentration, 1-7 wt. percentage of Ni, 1-15 wt. percentage of Cu and 1-5 wt. percentage of Fe.

2. The method according to claim 1, wherein subjecting the area of at least one of the bowl edge and the bowl base to the welding treatment introduces at least one of the following additional elements at the specified concentration, 1-7 wt. percentage of Ni, 1-15 wt. percentage of Cu and 0.5-5 wt. percentage of Fe.

3. The method according to claim 1, wherein the welding treatment includes at least one of the following with the specified ratio of arc energy input per unit length/weld penetration area E/A (J/mm³): (i) arc welding, via tungsten inert gas welding with E/A=7-17 J/mm³, (ii) arc welding via plasma welding with E/A=6-16 J/mm³, (iii) laser beam welding with E/A=80-90 J/mm³, and (iv) electron beam welding with E/A=5-15 J/mm³.

4. The method according to claim 2, wherein the welding process includes at least one of the following with the specified energy input per unit length E (J/mm): (i) arc welding, via tungsten inert-gas welding with E=150-450 J/mm, (ii) arc welding via plasma welding with E=250-700 J/mm, (iii) laser beam welding with E=100-400 J/mm, and (iv) electron-beam welding with E=500-900 J/mm, wherein the additional elements are pre-heated to a temperature above room temperature.

5. The method according to claim 1, wherein the welding treatment introduces at least one of the following additional elements at the specified concentration, 2-7 wt. percentage of Ni, 3-15 wt. percentage of Cu and 1-5 wt. percentage of Fe.

6. The method according to claim 2, wherein the welding treatment introduces at least one of the following additional elements at the specified concentration, 2-7 wt. percentage of Ni, 3-15 wt. percentage of Cu and 0.5-1 wt. percentage of Fe.

7. The method according to claim 1, wherein the welding produces intermetallic phases with a maximum longitudinal extension of less than 50 microns.

8. The method according to claim 1, wherein the base material includes, with the following composition, Al of 60-90 wt. percentage, Si of 8-20 wt. percentage, Cu of 2-6 wt. percentage, Ni of 1-4 wt. percentage and Mg of 0.2-2 wt. percentage.

9. The method according of claim 1, wherein the base material includes, with the following composition, Al of 75-85 wt. percentage, Si of 10-13 wt. percentage, Cu 3.5-5 of wt. percentage, Ni of 1.5-2.5 wt. percentage and Mg of 0.5-1.5 wt. percentage.

10. The method according to claim 1, further comprising supplementing the base material with at least one of the additional elements, each at a concentration of less than 1 wt. percentage, Fe, Mn, Ti, Zr, V, Ca, Sr, Na, and P.

11. The method according to claim 1, wherein the welding treatment includes adding the at least one additional element directly to a molten pool formed during welding in the form of at least one of a powder and a wire.

12. The method according to claim 1, further comprising applying the at least one additional element to the base material before the welding process via at least one of thermal spraying, cold gas spraying, foil, paste, galvanic deposition and chemical deposition.

13. The method according to claim 1, wherein the welding treatment includes using at least one of metal-inert gas welding, laser plasma powder hybrid welding and laser-MIG hybrid welding.

14. An aluminium piston for an internal combustion engine, comprising: a piston bowl composed of a base material, the bowl having a bowl edge and a bowl base, wherein at least one of the bowl edge and the bowl base includes an intermetallic phase having a longitudinal extension of less than 50 microns, the intermetallic phase including at least one of the following elements at the specified concentrations: 1-7 percentage by weight of Ni, 1-15 percentage by weight of Cu, and 1-5 percentage by weight of Fe.

15. The piston according to claim 14, wherein the base material includes, with the following compositions: 75 to 85 percentage by weight of Al, 10 to 13 percentage by weight of Si, 3.5 to 5 percentage by weight of Cu, 1.5 to 2.5 percentage by weight of Ni, and 0.5 to 1.5 percentage by weight of Mg.

16. The method according to claim 3, wherein the base material includes, with the following compositions: 75 to 85 percentage by weight of Al, 10 to 13 percentage by weight of Si, 3.5 to 5 percentage by weight of Cu, 1.5 to 2.5 percentage by weight of Ni, and 0.5 to 1.5 percentage by weight of Mg.

17. The method according to claim 4, wherein the additional elements are pre-heated to a temperature ranging from 100 to 300° C.

18. The method according to claim 9, further comprising supplementing the base material with at least one of the additional elements of Fe, Mn, Ti, Zr, V, Ca, Sr, Na and P, each at a concentration of less than 1 percentage by weight.

19. A method for producing a piston for an internal combustion engine, comprising:
forming a piston bowl having a bowl edge and a bowl base from a base material, the base material including, with the following compositions: 75 to 85 percentage by weight of Al, 10 to 13 percentage by weight of Si, 3.5 to 5 percentage by weight of Cu, 1.5 to 2.5 percentage by weight of Ni, and 0.5 to 1.5 percentage by weight of Mg; and
introducing at least one additional element into the base material via welding to produce intermetallic phases having a longitudinal extension of less than 50 microns, the at least one additional element including at least one of the following: 2 to 7 percentage by weight of Ni, 3 to 15 percentage by weight of Cu and 1 to 5 percentage by weight of Fe;
wherein the welding includes at least one of the following with the specified ratio of arc energy/weld penetration area ratio (E/A): tungsten inert gas welding with an E/A of 7 to 17 J/mm³, plasma welding with an E/A of 6 to 16 J/mm³, laser beam welding with an E/A of 80 to 90 J/mm³, and electron beam welding with an E/A of 5 to 15 J/mm³.

20. The method according to claim 18, further comprising supplementing the base material with at least one of the additional elements of Fe, Mn, Ti, Zr, V, Ca, Sr, Na and P, each at a concentration of less than 1 percentage by weight.
